(19) United States
(12) Patent Application Publication
(10) Pub. No.: US 2007/0288341 A1
(43) Pub. Date: Dec. 13, 2007

(54) FINANCIAL INSTRUMENTS BASED ON POOLS OF RAW LAND PARCELS AND SYSTEMS AND INDICES FOR TRADING SUCH INSTRUMENTS IN A SECONDARY MARKET

(76) Inventor: Andrew I. Shapack, Franklin, MI (US)

Correspondence Address: PAUL, HASTINGS, JANOFSKY & WALKER LLP, 875 15th Street, NW, Washington, DC, 20005, US

(21) Appl. No.: 11/760,643

(22) Filed: Jun. 8, 2007

Related U.S. Application Data
(60) Provisional application No. 60/804,240, filed on Jun. 8, 2006.

(51) Int. Cl. G06Q 40/00

(52) U.S. Cl. 705/36 R

(57) ABSTRACT

A method for creating, marketing and selling financial instruments derived from diversified pools of raw land parcels and a financial index that weighs statistical indicators related to land value. These securities will be tradable, on an exchange or over the counter, in a secondary market using the current financial infrastructure of investment banks, brokers, dealers, market specialists and retail customers. The market prices of these securities may be determined by: (1) the composite index customized from existing benchmarks, leading market indicators and government data providers; and/or (2) supply and demand.

### CROSS-REFERENCES TO RELATED APPLICATIONS

This application claims the benefit of U.S. Provisional Application No. 60/804,240, filed on Jun. 8, 2006, which is incorporated herein by reference in its entirety for all purposes.

### FIELD OF THE INVENTION

The present invention relates generally to financial products, and more particularly to financial products and related indices and systems for structuring ownership interests in pools of raw land parcels and offering securities based on these raw land parcels, preferably via either a registered public offering or an exempt private placement, freely tradable in a secondary market.

### BACKGROUND OF THE INVENTION

There is a rapidly increasing population in the United States and a diminishing supply of suitable land to meet the ever growing demand for expansion. This population boom and land shortage situation is born of several inescapable trends. First, the U.S. population, which has doubled since 1950, is now 300 million and is expected to add another 100 million people in the next 40 years. Second, the “baby boomers” (78 million), formerly the largest U.S. generation, created the current largest U.S. generation, the “echo boomers” (82 million), and they'll co-exist for another 35 years due to the baby boomer's record-breaking longevity. Third, U.S. zoning laws, which split land into different zones and spread out populations, caused this nation to consume the land supply too quickly. Fourth, the number of persons per household has trended downward for twenty years, with an average of 2.57 persons per household in 2004 and a projection of 2.1 in 2025. As the population increases, and the number of persons per household decreases, more land will be needed to accommodate more homes. Fifth, the proportion of marriages that will result in divorce is 50%, which often translates to multiple homes for the same family. Sixth, an estimated $48 trillion dollars will pass from the WWII generation to their baby boomer children. This has been called the greatest transfer of wealth in world history, and baby boomers are expected to purchase second homes for themselves and first homes for their echo boomer children concurrent with this wealth transfer.

Finally, 1 of out of 3 three acres in the United States is owned by the federal government. After wetlands, desert, parks, wildlife preserves, military installations, heavy forest, railroads, airports and existing development, the demand shift created by a growing U.S. population will be significantly challenged by the constraints of a fixed land supply.

In 2030, about half of the buildings in which Americans live, work and shop will have been built after 2000, thus, an estimated need of 44% more total built space than existed in 2000 to accommodate population and job-growth projections. Most of the space built between 2000 and 2030 will be residential space, and most of the new growth is projected in particular regions of the United States, the south and west.

Accordingly, investment in this transitional phase raw land, in high growth geographic areas, located within the path of progress, can offer potentially outsized returns in relation to the limited downside risk.

Traditionally, governments, corporations and ultra wealthy-generational families were the only beneficiaries of the historical high performance of raw land investments while ordinary investors have been excluded from the benefit of this asset class. In fact, despite the high degree of sophistication in the U.S. financial markets, and the commonly regarded instinct that transitional phase raw land, in high growth areas, located within the path of progress, appreciates in value, there is no financial instrument whose sole purpose is to allow all levels of the investment community access to the benefits of investment and sale of strategically selected raw land parcels.

Moreover, if individuals currently wanted to benefit from the investment and sale of transitional phase raw land, they would need to literally “knock on the farmhouse door.” This is not a realistically safe option, as it requires detailed knowledge relating to which farm or parcel to approach, in which geographic area, and comfort with the challenges of financing raw land and avoiding the obstacles of soils, utilities and zoning regulations. There is no practical or easily available manner for an ordinary investor to include transitional phase raw land appreciation in their investment portfolio, despite the well known historically high performance of this asset class and constant warnings regarding the importance of diversifying one's investments.

The present invention provides investors with access to the benefit of transitional phase raw land, professionally selected and managed, by leveraging the capital markets, in the form of an investment security, offering undivided ownership interest in a diversified pool of land assets with liquidity provided by a secondary market.

### SUMMARY OF THE INVENTION

The present invention discloses methods and systems for creating a financial instrument from land parcels, methods and systems for creating a financial index that weighs statistical indicators related to land value and measures change, as well as methods and systems for trading these securities in a secondary market.

In a preferred embodiment, the land parcels are combined into pools, i.e., a grouping of land parcels under a single ownership. Also, it is preferable the pools of land parcels are diversified pools, i.e., the land parcels within the pool are located in a variety of different geographic areas. Finally, it is preferable that the land parcels are raw land, whereby the land is vacant.

In one embodiment, a method for creating a financial instrument from pools of land parcels and a system for trading the financial instrument's securities in a secondary market is disclosed, the method and system comprising a registered common stock offering selling shares of a corporation, trust or other entity, that purchases raw land parcels. In one aspect of this embodiment, the financial instrument is tied to a composite index. In another aspect, the financial instrument is sold via an exempt private placement transaction. In yet another aspect, the financial instrument is split into different tranches and each tranch represents a different risk/return profile. For example, the tranch may be identified by a profile selected from the group consisting of the raw land parcel's zoning classification, geographic location, or stage of ripeness for development.

In another embodiment, a method for creating a financial instrument from pools of land parcels and a system for trading the financial instrument's securities in a secondary market is disclosed, the method and system comprising creation of a mutual fund by traditional formation of an investment company that purchases land parcels. In one aspect, the shares of the investment company are valued by a composite index. In another aspect, the shares of the investment company are valued by a combination of a composite index and regularly scheduled property appraisals.

Another embodiment discloses a method for creating a financial instrument from pools of land parcels and a system for trading the financial instrument's securities in a secondary market comprises formation of a closed-end fund. In one aspect, the closed-end fund's shares are valued by a composite index. In another, the closed-end fund's shares are valued by a combination of a composite index and regularly scheduled property appraisals.

Another embodiment of the invention comprises creation of an exchange-traded fund. In one aspect, the exchange-traded fund's shares are directly tied to a composite index. In another aspect, the exchange-traded fund's shares are valued by a combination of a composite index and regularly scheduled appraisals.

A further embodiment of the invention comprises a debt or bond offering issuing shares to the investing public. In one aspect, the shares are issued after the purchase of the raw land parcels. In another aspect, the shares are issued before the purchase of the raw land parcels. In yet another aspect, the bond prices are directly tied to a composite index. The bonds may be sold via an exempt private placement transaction. Additionally, the bonds may be split into different tranches wherein each tranch represents a different risk/return profile, including zoning classification, geographic location and stage of ripeness for development.

A still further embodiment of the invention comprises a laddering fund selling shares to the investing public. In one aspect, the laddering fund sells shares as an annuity.

A further method of the invention comprises issuing structured notes or certificates to investors. In one aspect, the structured notes or certificates have features selected from the group consisting of: guaranteed investor's principal, guaranteed rate of return for investors, protection from inflation and bonus returns for investors when the assets perform well. The structured note or certificate's prices may also be tied directly to a composite index.

Further embodiments of the invention comprise (i) either selling futures contracts or options contracts to investors or creating tenants in common interests, or (ii) a Tax-Deferred Exchange which is accomplished when land owners directly exchange the land asset as consideration for the securities of this invention. The land value would determine the number of shares exchanged.

Also disclosed is a method for creating a financial instrument from pools of land parcels and a system for trading the financial instrument's securities in a secondary market, the method and system comprising a composite index that measures change in relevant statistical data and suggests the share prices of the securities. In one aspect, the composite index comprises at least one geographic area index of a market where the land backing the security is owned. Alternatively, the composite index may comprise at least one geographic area index that does not represent the areas where the land backing the security is located. The share prices of the securities may be tied directly to the composite index or, the share prices of the securities may only be suggested by the composite index. Alternatively, the composite index may be used in conjunction with periodic appraisals of the land assets backing the securities.

In summary, by applying the expected behavior of raw land in high growth areas, leveraging the benefits of the capital markets, and implementing structured finance in the form of an investment security, the present invention provides for (i) individuals and ordinary investors gaining access to the benefits of investment in this asset class, (ii) a substantially more efficient tool to purchase land assets and (iii) liquidity provided by negotiable securities tradable in a secondary market.

### DETAILED DESCRIPTION OF THE INVENTION

The present invention provides methods and systems for creating securities in land, and preferably in transitional phase raw land, methods and systems for creating a financial index that weighs statistical indicators related to land value and measures change in land value, as well as methods and systems for trading these securities in a secondary market. The provision and discussion of specific examples herein are for illustrative purposes only and are not intended to limit the scope of the present invention.

Unless defined otherwise, all technical and scientific terms used herein have the same meaning as is commonly understood by one of ordinary skill in the art to which this invention belongs. As used herein, the singular forms “a”, “an”, and “the” mean “at least one” or “one or more” unless the context clearly dictates otherwise.

It will be appreciated that the methods and systems of the invention may be utilized with many different types of land. In a preferred embodiment, the invention is to be utilized with “raw land,” which refers generally to vacant land in a substantially natural state without substantial human structures built thereon. In a more preferred embodiment, the invention is to be utilized with “transitional phase raw land,” or “transitional raw land” which refers to land located within the path of progress or development. It will be appreciated that the nature of raw land will change as the land enters the transitional phase. For example, as metropolitan areas expand, farmland and other low density, high acreage areas in its path, become inefficient, and will assume the characteristics of transitional phase raw land.

In general, the present invention provides a new financial instrument that enables investors to invest in diversified pools of transitional phase raw land parcels while creating an entirely new investment product for the global retail sales efforts of large brokerage houses.

It will be appreciated that a single entity may own all the land parcels comprising the pool. This entity, often called a “special purpose entity” or “single purpose entity”, may take the form of a corporation, trust, limited liability company, etc. This entity may be a subsidiary of the originator of the shares for this invention. Use of this single entity structure offers benefits including, tax advantages, bankruptcy remoteness, asset insulation and reduced liability. Further, once this entity owns two or more parcels, it is considered a “pool.” Therefore, a pool of land parcels refer to an entity owning two or more land parcels.

The present invention can be applied to any investment vehicle currently or hereinafter used by persons of ordinary skill in the art. For example, shares of stock can be created and sold to the investing public after (or even before) the purchase of the land parcels. In this case, the land parcels would be owned by a single entity that would offer shares to the public and all shareholders would own an undivided interest in the portfolio of land parcels. Proof of ownership of this financial product could be a traditional stock certificate in the custody of the investor, held by the brokerage house or agent, or any other manner currently used or to-be-used by the securities industry. Investor ownership information can be maintained using the technology of already existing computer hardware and software systems.

Additionally, a mutual fund can be created by traditional formation of an investment company that would purchase land parcels. The value of the investment company's shares is measured by the value of the land parcels. This value, commonly called the “NAV”, or net asset value, could be determined by a system of property appraisals, whereby the total value of all the parcels would be added, minus liabilities and divided by the number of outstanding shares. Investors in the mutual fund could redeem their shares with the investment company for cash at any time the net asset value is published.

Likewise, a principal-protected fund (whether open-ended, closed-ended, unit investment trust, or exchange-traded fund), may be employed to sell shares. This type of financial product may have certain guarantees, such as, guaranteed principal, guaranteed return, protection from inflation and/or a “bonus return” for excellent performance. These types of funds usually have three phases: (1) an offering phase of several weeks when investors can purchase the shares subject to the guarantee; (2) if the shares are held for the whole period, 3, 5, 10 years (as examples), the initial investment is guaranteed; and (3) after the guarantee period expires, the fund either liquidates, or operates without any guarantees.

Alternatively, a closed-end fund can be established, wherein the investment company's shares are not redeemable back to the investment company. These shares could be listed on an exchange and traded based on supply and demand. Additionally, shareholders can buy or sell throughout the trading day, not only at day's end, like mutual funds, open end funds or unit investment trusts.

In a further example of creating a financial instrument from pools of land parcels and a system for trading these securities in a secondary market, an Exchange-Traded Fund (“ETF”) can be established, which is both fully tradable throughout the day, and sellers of the shares receive the then-posted share price, i.e., not a discount to the NAV. In this method, an Authorized Participant, which is an entity chosen by an exchange-traded fund's sponsor to undertake the responsibility of obtaining the underlying assets needed to create the ETF, places land parcels in a trust and forms the “creation units” of the ETF. The creation units are traded for ETF shares and sold to the public. The raw land parcels remain in the trust, and the ETF shares trade in an open market.

A bond or other debt offering may also issue, the securities representing pools of land parcels to the investing public after (or even before) the purchase of the land parcels. The securities would be structured as debt representing a loan to the entity or special purpose trust that owns the land parcels. In the absence of interest payments, these bonds would accrue interest to the bondholder, payable at maturity.

In yet another example of financial instrument for pools of land parcels and a system for trading these securities in a secondary market, a laddering fund could sell shares of the security (for example as an annuity) and “ladder” a return to the shareholders without a full return of investor capital. In this method, the entity that owns the land parcels (trust, single-purpose entity, etc.) periodically sells land parcels in the open market. The sales proceeds can be distributed to the shareholders as interest payments or dividends. Some of the proceeds could also be used for additional land purchases, perhaps under Section 1031 exchanges. This cycle could “ladder” into perpetuity. Refinancing debt would be another method to return capital to shareholders.

A structured note, also called a “certificate”, can also be issued to investors. These structured notes have some or all of the following features: (i) guaranteed investor principal, (ii) guaranteed rate of return (possibly tied to the CPI for inflation protection), and/or (iii) “bonus” returns offered to investors if the assets perform exceedingly well. Other more complex features that can be used for hedging may be added to this product or the other financial products disclosed herein.

Additionally, futures and options contracts can be sold to investors who are seeking exposure to investments in land parcels. These securities are valued at some dollar amount, as an example, $100, times a composite index. These securities would allow investors to hedge other investments by selling short, or by holding long, allowing investors exposure to potential price appreciation.

A tenants in common (“TIC's”) interest can also be created when the securities represent a deeded interest, through the use of master deeds, on behalf of the shareholder, in the land assets.

A tax-deferred exchange is also within the scope of the present invention. A tax-deferred exchange is accomplished when land owners directly exchange the land asset as consideration for the securities of this invention. The land value would determine the number of shares exchanged. In short, any investment vehicle presently used or used in the future can be used to allow investment in land parcels. The tax-deferred exchange may involve a government entity, such as the Bureau of Land Management.

In one aspect, the present invention provides a new financial instrument referred to herein as the “Raw Land Zero.” The investments are called Raw Land Zero for their structural similarity to Zero Coupon Bonds. This popular type of bond does not produce cash flow, i.e., pay interest during the term of ownership; just like raw land does not generally produce income. Additionally, this invention and Zero Coupon Bonds return investor capital at maturity or expiration.

However, in the case of a Zero Coupon Bond, the investor capital returned is pre-determined and limited to a low yield. In contrast, one embodiment of the present invention envisions that the Raw Land Zero returns the investor's capital when the land parcel is sold, and the potential return to the investor is unlimited. Also, Raw Land Zeros offer capital gains tax preference, whereas Zero Coupon Bonds are taxed at ordinary rates and cause “phantom income” due to the Original Issue Discount.

In a preferred embodiment of this invention, the aforementioned financial products (or any other financial product presently or hereinafter used by persons used in the industry) can be linked to an index. An index is a statistical measure of the changes in a portfolio of assets whose purpose is to represent a designated portion of the overall marketplace and project general market conditions.

This index, called, for example, the “Raw Land Zero Composite Index”, will weigh statistical indicators related to land value and measure change, possibly to suggest values for the securities of the present invention. In one embodiment, the share prices can be directly tied to changes in the index. In another embodiment, the index would only serve as a barometer suggesting changes in value and supply and demand would set price. The composite index can be aided by regular appraisals of the land parcels to determine a traditional NAV (net asset value) of the fund or trust or otherwise suggest value.

As recognized by persons of ordinary skill in the art, indexes, e.g., the S&P 500, are operated by applying established rules and guidelines to objective information. Likewise, this composite index will collect data from unbiased, objective and regularly published sources and use that data to project general market conditions or suggest values for the securities of the present invention. Generally, the data providers should be unrelated third parties, such as the U.S. Census Bureau, Bureau of Labor Statistics, Department of Labor, or professional research institutions. Additionally, the rules and guidelines that weigh the different types of information are generally available to the investing public, so investors can decide if they agree with the method of establishing significance.

This composite index may be compiled from some or all of the following indicators and data providers, for example: Employment Growth, Population Growth, Household Growth, Household Income, Employment/Permit Ratio, New Home Sales, Existing Home Sales, Price Appreciation, Housing Inventory, Days on Market, Mortgage Interest Rates, Net Migration, Housing Starts, Inflation, Consumer Confidence, Loan to Value Ratios, Cost of Living Index, High School Graduation Rate, S&P MEAP Scores, State Income Tax, State Sales Tax, Largest Employing Industry Growth (NAICS), 6 Key Indicators of U.S. Economy (Real GDP and its components, Business Fixed Investments, Change in Business Inventories, Government Spending, Net Exports and Inflation/CPI/PPI), Earnings of Employees, Persons per Household, Total Retail Sales, national and local headline news.

The above data types will preferably be aggregated and weighted (assigned valued) based on their impact on raw land. The base year can be equal the 2000 national census and the index can be arbitrarily set at any number at its creation, e.g., 100. The index will adjust each time one of the above factors releases data. This could be daily, weekly, monthly or quarterly.

In one aspect of this preferred embodiment of the present invention, the composite index will include only those geographic areas with land investments by the securities-issuing company. In this situation, the composite index may be comprised of a certain number, for example, 24, of subset, geographic area indices corresponding to the number, for example, 24, parcels owned by the securities-issuing trust. As an illustration, a security-issuing company may own raw land parcels in Pescespada Island, Castle Rock and Greenbow. These specific, local, geographic area indices (“Local Index”), Pescespada Island Local Index, Castle Rock Local Index and Greenbow Local Index are compiled by aggregating and weighing data relevant to raw land prices in these areas as provided by government and other unbiased sources. The data formula will typically be available for investor review and understanding. Therefore, the composite index, would be averaged or proportioned from the group of Local Indexes, not unlike the Dow Jones Industrial Average is an average of the stock price of 30 large cap stocks.

In an alternative embodiment, the composite index is comprised of geographic area indices that do not represent the areas where the land backing the securities is located, but rather, a different method is used for determining the geographic areas that comprise the broader index. As an example, the composite index could include any geographic area with a population of 50,000 or greater.

In a preferred embodiment, published data is weighted based on its impact on raw land values. The data statistic “employment growth” may receive the greatest significance as an indicator and may, therefore, exert the greatest influence on the index. For example, if in Pescespada Island, Fla., there is an announcement that a Fortune 500 company is relocating there; the Pescespada Island Local Index will gain value (points) pursuant to the formulaic weighting of employment growth and population growth.

The composite index, preferably called Raw Land Zero Composite Index, will gain value (points) resulting from the Pescespada Island Local Index increase, assuming all other Local Indices remain equal. An investor in this invention would see their share prices increase as a result of positive change in Pescespada Island, Fla.

In another preferred embodiment, the composite index is proportioned based on the quantity and size of parcels in a geographic area. For example, if the securities-issuing company owns 800 acres in Metropolis City and 120 acres in Deadwood City, a change in the Metropolis City Local Index will impact the composite index to a greater degree than a change in the Deadwood City Local Index.

In an alternative embodiment, the composite index would be proportioned in a different method, possibly, for example, based on the purchase price of the land parcel(s).

These hypothetical examples ring true whether the securities are directly linked to the index, or the index only serves as a value suggestion. As a reminder, most well known indices, CPI, Consumer Confidence, S&P Mid-CAP, serve as barometers of the market they are interpreting. They impact the share price of both securities tied directly to them (e.g., index funds), and the universe of securities that are not.

Also, the composite index serves as a general market benchmark. Buyers and sellers of land, unrelated to this invention, would benefit from the composite index in their business dealings. For example, in an industry outside the securities marketplace, a real estate related contract between two parties could tie a future-date purchase price to the composite index (analogous to equipment leases linking future rent to the Consumer Price Index). As another benefit, third party use of this composite index, unrelated to the trading of these securities, would market and promote the popularity and general comfort of the composite index and the invention itself.

This composite index, proportioned from Local Indexes, which are computerized financial models whose data inputs are objective, well-known, and usually government sources, will preferably be maintained by third party, professional statisticians. The value of the composite index could be determined at any moment and electronically published throughout the world.

A system for trading the financial instruments of this invention in a secondary market may be accomplished using the composite index. A secondary market is a marketplace where securities are bought and sold after they have already been issued in an initial private or public offering. In the case of secondary markets for publicly traded securities, the trading occurs on an exchange or over the counter. Some examples are the New York Stock Exchange, NASDAQ, and American Stock Exchange.

In a preferred embodiment of the present invention, the financial instruments would trade in a secondary market, wherein the share prices would be valued by the composite index and shareholders could redeem their shares at that set price, similar to net asset value redemption models of mutual funds, or exchange-trade similar to an ETF or any other security available over the counter or on an exchange.

In an alternative to the preferred embodiment, the share prices will be affected by the composite index, but ultimately valued by the market, including through supply and demand. The composite index will likely affect demand. Just as changes in the Consumer Confidence Index affects the price for the stocks of homebuilders and auto manufacturers, changes in the composite index are likely to affect the price for financial products linked to raw land, e.g., Raw Land Zeros, as well as other related products.

In yet another alternative, the share prices can be determined by a system of regularly scheduled appraisals, or any other method accepted in the art.

This invention, irrespective of embodiment, has many benefits to the shareholder, securities-issuing company, real estate marketplace and investment community. Although not required, the following are some of the benefits found in embodiments of the present invention:

1. Capital gains. This invention may provide the investor with capital gains tax preference, if the invention is held in accordance with holding period regulations. Also, the sale of the land parcels, if owned for sufficient time by the securities-issuing entity, may be considered long-term capital gain and may be passed through to the investor.

2. Limited downside risk. It is unlikely that raw land parcels in high growth geographic areas located within the path of progress and development will significantly lose value.

3. Potential for high returns. Unlike other financial products, this invention does not limit return to the investor. It is not uncommon for transitional raw land, purchased at a bargain price, in a high growth area, located within the path of progress, to appreciate significantly with development momentum.

4. Conservative leverage. Depending on the embodiment of the invention, the financial products may be based on leverage. Higher rates of debt are common in real property investments, and can add risk. The invention may use more or less debt, thereby allowing for potential investment returns to be higher without the dangers of “over-borrowing.”

5. Access. This invention solves the historic problem of investors being excluded from portfolio exposure to raw land profits.

6. Investment Portfolio Diversification. The principle of investment portfolio diversification is greatly assisted by the inherent principles of raw land. The risk-return reality of this new invention is unlike other investments in an average portfolio. The value of these pooled land assets are primarily impacted by population growth, household growth and employment growth. The first two trends are substantially irreversible. Most investments are impacted by interest rates, inflation and corporate earnings. While they are long-established value determinants, they vary in their impact on raw land; from low impact to none. Because the market factors that exercise the greatest impact on raw land values are significantly different from, and not correlated to, many other investments in one's portfolio, this invention can provide insulation and counterweight. As the population boom and land shortage become better known, embodiments of this invention may become a trusted asset class allocation in every portfolio, just like stocks, bonds, options and commodities.

7. Education Funding. The present invention's longer investment horizons and safety from downside risk fit the goals of college savings strategies.

8. Gifting. It is common to use T-Bills, Government Bonds, Zero Coupon Bonds, as examples, as gifts for children, graduating seniors, etc. The present invention may be used to offer an improvement to that tradition.

9. Easy to understand. As a general matter, raw land in the path of progress and development is known to appreciate in value over time. Offering financial products based in part on this principle benefits buyers and sellers in the current securities market dominated by complex, confusing and difficult to understand alternatives.

10. Retirement Planning. This invention provides retirement accounts with potential stability and diversity the stock market cannot. Recent history has shown several Wall Street “darlings” experience unpredicted and immediate financial ruin resulting in substantial loss to the shareholder.

11. Liquidity. Investors often prefer liquid investments that can be easily sold. However, the raw land marketplace remains local, highly inefficient and without liquidity. The present invention offers investors the liquidity and flexibility of negotiable securities tradable in a secondary market.

12. Efficient Purchase of Land Assets. Utilizing the capital markets brings efficiency to a currently inefficient marketplace, whether by aggregating parcels of raw land into negotiable securities or selling stock in the land owning company. The capital markets offer the ability to more efficiently raise funds from a global marketplace quickly and with lower cost.

13. Pooled Capital. When investors pool their capital to purchase assets, they avoid the obstacles, challenges and limitations of individual, direct ownership. With pooled capital, they gain the benefits of “owning” the raw land parcels with a diminished risk, lower cost, greater liquidity and diversified interests. In addition, investors can bypass the very high barrier of entry of individual, direct ownership in raw land.

14. Diversified Pool of Raw Land Parcels. Diversification within an asset pool created by purchasing many land parcels, in a variety of different, or even the same geographic growth areas, spreads the investment risk and adds a margin of safety. In one embodiment, a diversified pool of raw land parcels limits an investor's risk of loss across scope and geography, which may minimize the impact of any one raw land value on overall portfolio performance. Land parcels in separate states are not directly related or similarly affected by the same variables.

15. Social Value. Ordinary investors (dentists, engineers, school teachers) are themselves the very “domestic migrants” who, along with their families, are causing the population boom and land shortage in the first place. This invention allows them the potential access and portfolio gain in the value they are creating.

16. Estate Planning. Raw land can be an obstacle in tax and estate planning. Often, the beneficiaries of large parcels of raw land are challenged by an illiquid asset, unfamiliar with land management and may live elsewhere. This invention allows the possible transfer of the raw land asset into the investment securities described herein. The inheritors may benefit from liquid securities for their own, undivided use,

17. Currency. The securities-issuing company can use this financial products described herein as a method to purchase raw land parcels. One embodiment of this invention will provide for the exchange of a raw land parcel for shares of this security while deferring tax recognition for the seller. Moreover, strategic corporate finance may assist the securities-issuing company with a lower cost of capital by using this invention to purchase land assets, in favor of other, more expensive, capital sources.

18. Improvement upon current methods. An investor's purchase and individual, direct ownership in a parcel of raw land is far riskier than an equal amount invested in the securities of the present invention. As an example, a $100,000 investment in a 10 acre parcel in Future Growth Hills, USA is greatly improved upon by a $100,000 investment in the shares of the present invention. The shares offer an undivided interest in a variety of different land parcels located throughout the United States or other, even global, geographic region, selected and managed by experts. Also, the liquidity of the secondary market provides for exit options that direct ownership cannot, absent this invention.

19. Limited management risk. The present invention requires little management. The assets may be isolated in a special trust, corporation or other type of entity discussed above, designed for the limited purpose of holding them. The trust has no other business purpose except maximizing their value. The operations of the securities-issuing company require few employees, and limited management actions other than purchase, hold, and then sell.

20. Safe exposure to “excess returns.” Excess returns have historically been possible in those “off the beaten path” areas of the market that remain less efficient. It often requires capital to unleash the potential of excess returns, The present invention allows ordinary investors possible access to “off the beaten path” opportunities while engaging the efficiency of the capital markets with a structured product. For example, it would be highly difficult, in the absence of this invention, for a pharmacist in Allentown, Pa. to profit from a 230 acre ranch along 1-25 in between Albuquerque and Santa Fe.

21. Uniform Valuation Method. As described above as the composite index, this aspect of the invention solves the problem of an absent uniform valuation method for raw land. Buyers and sellers of both the securities of this invention, and real estate in ordinary transactions, will benefit from this guide for value and pricing in an objective and reliable manner.

It should be noted that the present invention is not limited to any specific rules or guidelines regarding management of the composite index, or even by the detailed forms, types or structures of securities discussed above. Additionally, unless expressly stated to the contrary, the claims of the present invention are not meant to be limited by the type of instrument (debt or equity), the type of offering (public or private exempt offering), the time of sale (land purchases occurring before or after the sale of the securities described herein), any linkage to the composite index, appraisals or other index, to a diversified (as opposed to non-diversified) pool of land parcels, by grouping characteristics (e.g., tranched or non-tranched securities) or tax status (e.g., tax-deferred or otherwise).

Indeed, with respect to tranches, any investment product of the present invention can be split into groups (called tranches) based on characteristics of interest to a person of ordinary skill in the art. For example, each tranch may represent a different risk/return profile, including, but not limited to, zoning classification, geographic location and stage of ripeness for development.

It will further be appreciated that the entity holding the raw land will have management fees and other ongoing operational expenses, e.g., payment of real estate taxes, and that these fees and expenses may affect share pricing as they do in other securities.

The examples and discussion above are put forth so as to provide those of ordinary skill in the art with a complete disclosure and description of how to make and use various embodiments of the present invention, and are not intended to limit the scope of what the inventors regard as their invention nor are they intended to represent that the examples above are all or the only examples performed.

1. A financial instrument based on diversified pools of raw land parcels.

2. The financial instrument according to claim 1 based on options to purchase land parcels.

3. The financial instrument according to claim 1 wherein the financial instrument is selected from the group consisting of: a stock (or other equity) offering, a mutual fund, a closed end fund, an exchange traded fund, a bond or other debt offering, including convertible to equity, a laddering find, an annuity, structured notes/certificates, including principal, return and inflation protection, futures contracts and options, tax-deferred exchanges, tax-deferred exchanges involving a government entity, and tenants in commons interests.

4. The financial instrument according to claim 1 wherein the financial instrument is linked to an index.

5. The financial instrument according to claim 1 wherein the financial instrument is valued by any of the group consisting of an index, supply and demand in the marketplace and regularly scheduled appraisals.

6. The financial instrument of claim 1, wherein the financial instrument is sold via a publicly offered registration.

7. The financial instrument of claim 1, wherein the financial instrument is sold via an exempt private placement transaction.

8. The financial instrument of claim 1, wherein the financial instrument is split into different tranches and each tranch represents a different risk/return profile.

9. The financial instrument of claim 8 wherein the tranches are selected based on criteria consisting of: zoning classification, geographic location, and stage of ripeness for development, as examples.

10. A financial index that weighs statistical indicators related to land value.

11. The financial index according to claim 10 whose purpose is to suggest the value of land.

12. The financial index according to claim 10 that comprises at least one statistical indicator for the geographic area where land backing a security is owned.

13. The financial index according to claim 10 that comprises at least one statistical indicator for a geographic area that does not represent areas where land backing a security is located.

14. The financial index according to claim 10 wherein the value of such index is based on some or all of the criteria selected from the group consisting of:
Employment Growth, Population Growth, Household Growth, Household Income, Employment/Permit Ratio, New Home Sales, Existing Home Sales, Price Appreciation, Housing Inventory, Days on Market, Mortgage Interest Rates, Net Migration, Housing Starts, Inflation, Consumer Confidence, Loan to Value Ratios, Cost of Living Index, High School Graduation Rate, S&P MEAP Scores, State Income Tax, State Sales Tax, Largest Employing Industry Growth (NAICS), 6 Key Indicators of U.S. Economy (Real GDP and its components, Business Fixed Investments, Change in Business Inventories, Government Spending, Net Exports and Inflation/CPI/PPI), Earnings of Employees, Persons per Household, Total Retail Sales, National and local headline news.

15. The financial index according to claim 10 that is a composite index comprised of subset indices.

16. A method for valuing the financial instruments of claim 1 using a financial index that weighs statistical indicators related to land values, supply and demand in the marketplace, or regularly scheduled appraisals.

17. The method according to claim 16 wherein the financial instruments are traded in a secondary market.

18. The method according to claim 17 wherein the secondary market is publicly-traded.

19. The method according to claim 17 wherein the secondary market is privately-traded.

20. The method according to claim 16 wherein the financial instruments are valued by said financial index.
